(19) United States
(12) Patent Application Publication
(10) Pub. No.: US 2007/0141904 A1
(43) Pub. Date: Jun. 21, 2007

(54) WATERPROOF CONNECTOR

(76) Inventor: Toshiaki Hayashi, Aichi (JP)

Correspondence Address: BARLEY SNYDER, LLC, 1000 WESTLAKES DRIVE, SUITE 275, BERWYN, PA, 19312, US

(21) Appl. No.: 11/613,167

(22) Filed: Dec. 19, 2006

(30) Foreign Application Priority Data
Dec. 19, 2005 (JP) 2005-364971

(51) Int. Cl. H01R 13/40

(52) U.S. Cl. 439/587

(57) ABSTRACT

A waterproof connector having an insulative housing having a hood receiving section adapted to mate with a mating hood of a mating connector, a contact attached to said housing, a sealing member disposed between an inner periphery of the hood receiving section and an inner periphery of the mating hood of the mating connector, and a drain hole formed in the hood receiving section for draining any water that infiltrates the hood receiving section is disclosed.

### CROSS-REFERENCE TO RELATED APPLICATIONS

This application claims the benefit of the filing date under 35 U.S.C. § 119(a)-(d) of Japanese Patent Application No. 2005-364971, filed Dec. 19, 2005.

### FIELD OF THE INVENTION

The present invention relates to a waterproof electrical connector.

### BACKGROUND

Waterproof electrical connectors have been known for a very long time. Referring now to Prior Art FIGS. 9-13, a conventional waterproof connector disclosed by Japanese Patent Document JP H10-003963A is illustrated. Prior Art FIG. 9 is an oblique view of a conventional waterproof connector with the rear holder and contacts removed. Prior Art FIG. 10 is an oblique view illustrating the contact assembly step. Prior Art FIG. 11 is a partial cross-section of the main components in Prior Art FIG. 10. Prior Art FIG. 12 is an oblique view of the waterproof connector after a mating connector has been fitted. Finally, Prior Art FIG. 13 is a partial cross-section of the main components in Prior Art FIG. 12.

In Prior Art FIGS. 9-13, a waterproof connector 101 comprises insulative housing 110, a plurality of contacts 120 attached to the insulating housing 110, a family seal 130 (hereinafter referred to simply as a sealing member) that is mounted to the insulating housing 110, and a rear holder 140.

The housing 110 is formed in a substantially rectangular shape having on its front side (the side in the back in Prior Art FIG. 12) a fitting concave part (not shown) that fits with a mating connector 160, and provided on its rear side with a sealing member holding concave part 111, as shown in Prior Art FIG. 11. Also, two pairs of fixed plate latching holes 112 are provided as shown in Prior Art FIG. 9 to the portions of both side walls of the housing 110 farther to the rear than the sealing member holding concave part 111, and a pair of slits 113 are formed so as to open up the rear edge of the housing 110. A low insertion force lever 150 is provided to the housing 110 so as to be capable of rotating around a shaft 151.

Also, the contacts 120 are formed by stamping and forming sheet metal, and are attached to the inside of the housing 110. Electrical wires W are connected to the contacts 120, and these electrical wires W are taken out from the rear face of the housing 110 to the outside.

The sealing member 130 is formed in a substantially rectangular shape with a cluster-type waterproof member made of rubber and is mounted from the rear of the housing 110 to the sealing member holding concave part 111 of the housing 110. The outer peripheral face of the sealing member 130 fits snugly against the inner peripheral face of the sealing member holding concave part 111 and prevents water from infiltrating the inside of the waterproof connector 101. A plurality of wire receiving passageways 131, into which the electrical wires W connected to the contacts 120 are inserted, are formed in the sealing member 130. The function of the wire receiving passageways 131 is to fit snugly around the electrical wires W and prevent water from infiltrating the interior of the waterproof connector 101.

Further, the rear holder 140 is equipped with a fixed plate 141 having a plurality of insertion holes 141a that cover the rear face of the sealing member 130 and are used to insert the electrical wires W, and a movable plate 142 having a plurality of insertion holes 142a that are disposed to the rear of the fixed plate 141 and are used to insert the electrical wires W. Two pairs of latching protrusions 141b that latch into the fixed plate latching holes 112 provided to the housing 110 are provided to the edges on both sides of the fixed plate 141. When the latching protrusions 141b of the fixed plate 141 latch into the fixed plate latching holes 112 of the housing 110, as shown in Prior Art FIG. 11, the fixed plate 141 presses on the rear face of the sealing member 130, and this prevents the sealing member 130 from coming loose from the housing 110. Also, as shown in Prior Art FIG. 9, the four corners of the fixed plate 141 are provided with four lock arms 141c that latch the movable plate 142 and, under the action of a specific force, release the latched movable plate 142 and move it away. Meanwhile, a pair of guide protrusions 142b that are guided by the slits 113 provided to the housing 110 are provided to the edges on both sides of the movable plate 142, and the movable plate 142 is able to move forward and backward with respect to the fixed plate 141 as shown in Prior Art FIGS. 11 and 13.

With the waterproof connector 101 constituted as above, first, as shown in Prior Art FIGS. 10 and 11, the sealing member 130 is mounted in the sealing member holding concave part 111 of the housing 110, the fixed plate 141 of the rear holder 140 is fixed to the housing 110, and the movable plate 142 is brought into contact with the fixed plate 141, and in this state the contacts 120 are latched to the housing 110 by being inserted through the wire receiving passageways 131 of the sealing member 130, the insertion holes 141a of the fixed plate 141, and the insertion holes 142a of the movable plate 142 from the rear side of the housing 110.

Then, the low insertion force lever 150 is rotated in the direction of the arrow in Prior Art FIG. 12 and positioned at its end position as the mating connector 160 is fitted. This completes the fitting of the mating connector 160, and the guide protrusions 142b are pushed toward the rear end by the low insertion force lever 150 while being guided by the slits 113. As a result, the movable plate 142 is pulled away from the fixed plate 141 that is fixed to the housing 110, and hits protrusions 114 provided to the housing 110, as shown in Prior Art FIGS. 12 and 13. A gap L is set between the fixed plate 141 and the movable plate 142 as shown in Prior Art FIG. 13.

Since the gap L is thus set between the fixed plate 141 and the movable plate 142, even if the electrical wires W are pulled and displaced laterally as indicated by the imaginary lines in Prior Art FIG. 13, the electrical wires W will be restricted by the insertion holes 142a and the gap L and will not be deformed at the location where they are in contact with the wire receiving passageways 131 of the sealing member 130. Accordingly, there will be no deformation of the sealing member 130 as the electrical wires W bend, nor any decrease in the contact between the wire receiving passageways 131 and the electrical wires W, thereby maintaining the waterproof nature of the connector.

Referring now to Prior Art FIGS. 14 and 15, another example of a conventional waterproof connector as disclosed by Japanese Patent Document JP2000-353570A is illustrated. Prior Art FIG. 14 is a cross-section of another example of a conventional waterproof connector, and Prior Art FIG. 15 is a partial cross-section of the main components of the waterproof connector of FIG. 14.

The waterproof connector 201 shown in Prior Art FIG. 14 comprises a housing 210, a plurality of contacts 220 connected to electrical wires W, a plurality of first sealing members 230, and a second sealing member 240.

Here, the housing 210 is made up of an inner housing 211 in which a plurality of contact holding cavities 211 a for holding contacts 220 are formed in the vertical and sideways directions; an outer housing 212 into the interior of which is fitted this inner housing 211; and a spacer 213 that is interposed between the inner housing 211 and the outer housing 212 and supports the contacts 220 held in the contact holding cavities 211 a of the inner housing 211.

The outer housing 212 comprises a cylindrical inner housing holder 214 into which the inner housing 211 is fitted, and a hood 215 that extends forward (to the left in Prior Art FIG. 14) from the inner housing holder 214 so as to cover the entire periphery of the inner housing holder 214. A fitting concave part 216 that accepts the hood of a mating connector (not shown) is formed between the hood 215 and the inner housing holder 214. Meanwhile, a cylindrical component composed of a rear wall 212a and a peripheral wall 212b is provided as shown in Prior Art FIG. 15 to the rear side of the inner housing holder 214. Electrical wire insertion holes 217 are formed at locations across from the respective contact holding cavities 211a of the rear wall 212a of this cylindrical component, and sealing member holding concave parts 218 are formed at locations across from the respective electrical wire insertion holes 217, which are on the inside of the cylindrical component. The first sealing members 230 are held in the sealing member holding concave parts 218. The first sealing members 230 are seal plugs made of rubber, and each fits snugly around the periphery of a single electrical wire W connected to a contact 220, thereby preventing water from infiltrating the interior of the waterproof connector 201.

Also, as shown in Prior Art FIG. 15, drain openings 219a, 219b, and 219c are formed in the portions of the peripheral wall 212b of the outer housing 212 not sealed by the first sealing members 230 (the corner portions at the boundary between the rear wall 212a and the peripheral wall 212b). The drain openings 219a, 219b, and 219c are formed so as to pass through linearly in the vertical direction of the peripheral wall 212b. The result of thus forming the drain openings 219a, 219b, and 219c so that they pass through linearly in the vertical direction of the peripheral wall 212b is that any water A (water droplets) that has infiltrated the sealing member holding concave parts 218 through electrical wire insertion openings on the outside of the electrical wire insertion holes 217 of the outer housing 212 can come out through the lowermost drain opening 219c as shown in Prior Art FIG. 15. Accordingly, water A will not collect in the sealing member holding concave parts 218, so the peripheral wall 212b and rear wall 212a will not be damaged by freezing, and this improves the reliability of the waterproofing provided by the sealing members 230.

Also, the sealing member 240 is a rubber waterproof member formed in an annular shape, and is disposed around the outer periphery of the inner housing holder 214 of the outer housing 212. This sealing member 240 fits snugly against the inner periphery of the hood of the mating connector held in the fitting concave part 216 and against the outer periphery of the inner housing holder 214 (that is, the inner periphery of the fitting concave part 216), and thereby prevents water from infiltrating the interior of the waterproof connector 201.

However, problems exist with the conventional waterproof connector 101 shown in Prior Art FIGS. 9-13 and the waterproof connector 201 shown in Prior Art FIGS. 14 and 15.

With regard to the waterproof connector 101 shown in Prior Art FIGS. 9 to 13, the movable plate 142 must be provided in addition to the fixed plate 141 that presses on the sealing member 130, in order to prevent a decrease in contact between the electrical wires W and the wire receiving passageways 131 and to prevent deformation of the sealing member 130 as the electrical wires W are bent. In other words, a special member must be provided for preventing a decrease in contact, in addition to the member that presses on the sealing member 130, which is a problem in that more parts are required. Also, the low insertion force lever 150 has to be rotated in order to move the movable plate 142, which complicates the work involved; for example, when the waterproof connector 101 is to be placed/inserted into a tight space, the installation work is more difficult. Furthermore, the function of guiding the electrical wires W linearly between the fixed plate 141 and the movable plate 142 is weak, and if the electrical wires W are forcefully bent when installing the waterproof connector 101 in a tight space, there is the risk of the sealing member 130 being deformed as the electrical wires W are bent, and a resulting decrease in contact between the wire receiving passageways 131 and the electrical wires W.

With regard to the waterproof connector 201 shown in FIGS. 14 and 15, any water A that infiltrates the interior of the sealing member holding concave parts 218 through the electrical wire insertion holes 217 of the outer housing 212 can be drained out from the drain opening 219c, but water that has infiltrated the fitting concave part 216 from the side where a mating connector is fitted up to just short of the second sealing member 240 cannot be drained. For example, with a waterproof connector used in an automotive door, the vehicle is sometimes left in a state in which infiltration of water from the side where a mating connector is fitted up to just short of the sealing member is unavoidable. If the water collects and freezes inside the fitting concave part 216, the portion of the housing 210 near the fitting concave part 216 may be damaged because it is unable to accommodate the volumetric expansion that occurs when collected water turns into ice.

### SUMMARY

The present invention was conceived in light of the above problems, and it is therefore, an object of the present invention to provide a waterproof connector with a simple construction that has few parts and is easy to work with. Further, it is an object of the present invention to provide a waterproof connector that, even if installed in a tight space that causes the electrical wires to be bent, the bending of the wires will not cause the cluster-type sealing member to deform and there will be no risk of a decrease in contact between the wire receiving passageways and the electrical wires.

It is another object of the present invention to provide a waterproof connector with which water that has infiltrated into the hood receiving section can be drained from the side where a mating connector is mated up to just short of the sealing member.

The waterproof connector of the present invention has an insulative housing; a plurality of contacts attached to said housing; a family seal that is mounted to the rear end of the housing and has a plurality of wire receiving passageways that fit snugly around a plurality of electrical wires connected respectively to the plurality of contacts; and a seal retention member that retains the cluster-type sealing member. A wire guide for linearly guiding the plurality of electrical wires is integrally formed on the seal retention member.

Furthermore, the present invention provides a waterproof connector having an insulative housing with a hood receiving section that accepts the mating hood of a mating connector; a contact that is attached to the housing; and a sealing member that fits snugly around the inner periphery of the hood receiving section and the inner periphery of the mating hood part of the mating connector. A drain hole for draining any water that infiltrates the hood receiving section is provided to the hood receiving section.

A waterproof connector according to the present invention has an insulative housing with a hood receiving section adapted to mate with a mating hood of a mating connector, a contact attached to said housing, a sealing member disposed between an inner periphery of the hood receiving section and an inner periphery of the mating hood of the mating connector, and a drain hole formed in the hood receiving section for draining any water that infiltrates the hood receiving section.

### BRIEF DESCRIPTION OF THE DRAWINGS

FIG. 1A is an oblique view from above and obliquely to the right of an embodiment of a waterproof connector according to the present invention;

FIG. 1B is an oblique view from above and obliquely to the left front of the waterproof connector of FIG. 1A;

FIG. 1C is an oblique view from below and obliquely to the left front of the waterproof connector of FIG. 1A;

FIG. 2A is an oblique view from above and obliquely to the left of the waterproof connector of FIG. 1A;

FIG. 2B is an oblique view from above and obliquely to the right rear of the waterproof connector of FIG. 1A;

FIG. 2C is an oblique view from below and obliquely to the right rear of the waterproof connector of FIG. 1A;

FIG. 3A is an orthogonal top view of the waterproof connector of FIG. 1A;

FIG. 3B is an orthogonal front view of the waterproof connector of FIG. 1A;

FIG. 3C is an orthogonal rear view of the waterproof connector of FIG. 1A;

FIG. 4A is an orthogonal left side view of the waterproof connector of FIG. 1A;

FIG. 4B is a cross-sectional view taken along the line 4B-4B of FIG. 3B of the waterproof connector of FIG. 1A;

FIG. 4C is an orthogonal bottom view of the waterproof connector of FIG. 1A;

FIG. 5A is an orthogonal front view of the waterproof connector of FIG. 1A as connected to a mating connector;

FIG. 5B is an orthogonal rear view of the waterproof connector of FIG. 1A as connected to the mating connector of FIG. 5A;

FIG. 5C is a cross-sectional view taken along the line 5C-5C in FIG. 5B of the waterproof connector of FIG. 1A as connected to the mating connector of FIG. 5A;

FIG. 6A is an orthogonal left side view of the waterproof connector of FIG. 1A as connected to the mating connector of FIG. 5A;

FIG. 6B is an orthogonal bottom view of the waterproof connector of FIG. 1A as connected to the mating connector of FIG. 5A;

FIG. 7 is an orthogonal right side view of the waterproof connector of FIG. 1A as connected to the mating connector of FIG. 5A;

FIG. 8 is a cross-sectional view taken along the line 5C-5C in FIG. 5B of the waterproof connector of FIG. 1A as connected to the mating connector of FIG. 5A and illustrating that water which has infiltrated a hood receiving section is drained;

Prior Art FIG. 9 is an oblique view of a conventional waterproof connector when the rear holder and contacts have been removed;

Prior Art FIG. 10 is an oblique view illustrating a contact assembly step related to the conventional waterproof connector of Prior Art FIG. 9;

Prior Art FIG. 11 is a partial cross-sectional view of the main components of Prior Art FIG. 10;

Prior Art FIG. 12 is an oblique view of the conventional waterproof connector of Prior Art FIG. 9 as connected to a mating connector;

Prior Art FIG. 13 is a partial cross-sectional view of the main components of Prior Art FIG. 12;

Prior Art FIG. 14 is a cross-sectional view of another conventional waterproof connector; and

Prior Art FIG. 15 is a partial cross-sectional view of the main components of the waterproof connector of Prior Art FIG. 14.

### DETAILED DESCRIPTION OF THE EMBODIMENT(S)

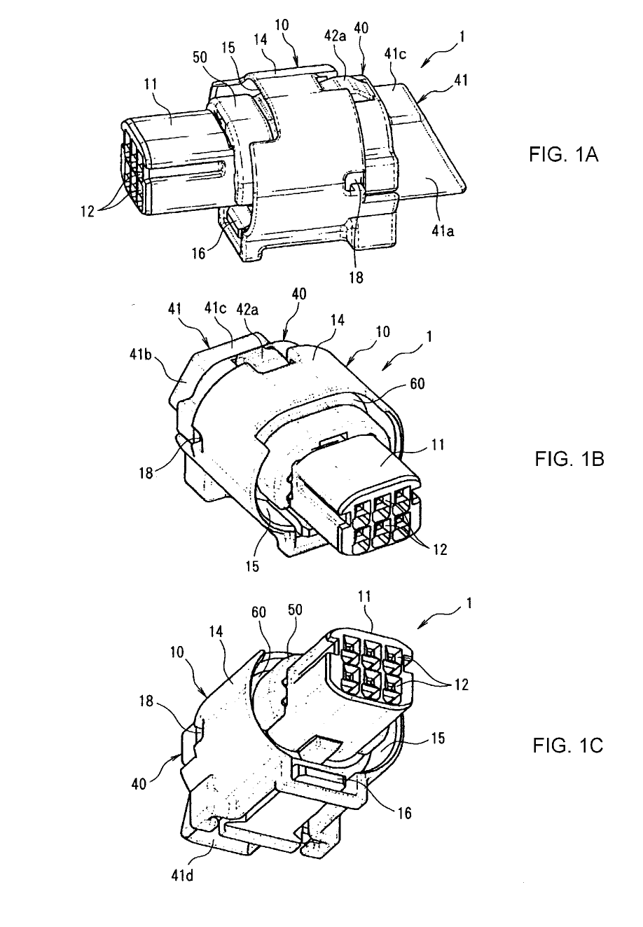

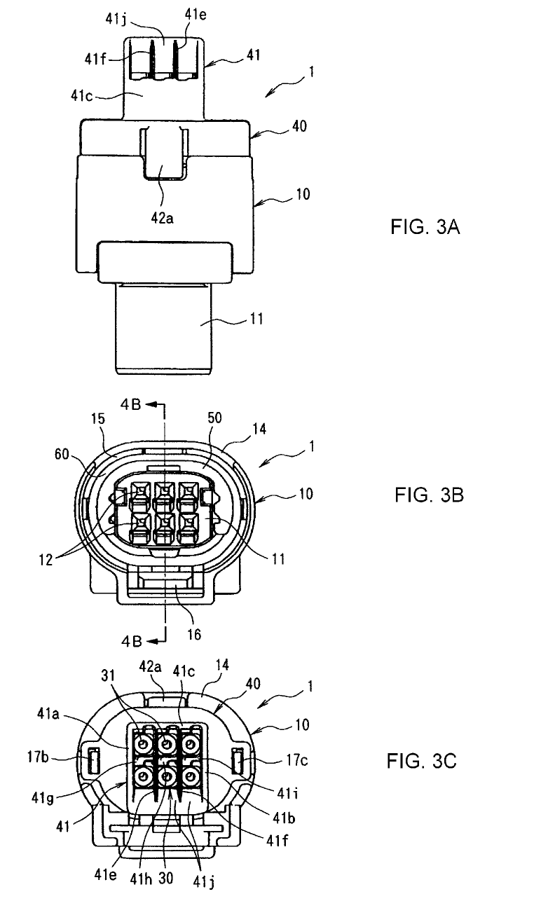

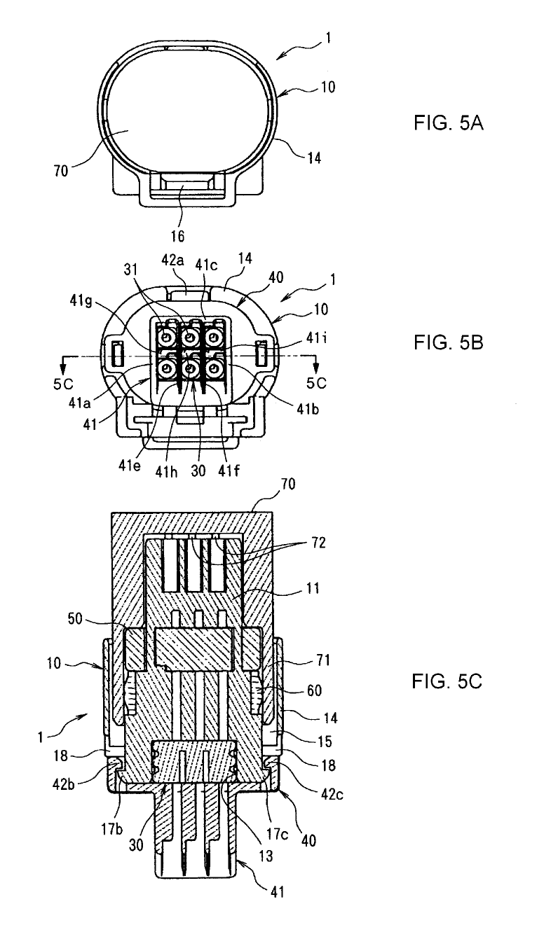

Referring first to FIGS. 1A-4C, a waterproof connector 1 comprises an insulative housing 10, a plurality of contacts 20 attached to the housing 10, a family seal 30, a seal retention member 40, a secondary latching member 50, and a sealing member 60. In the description that follows, the leftward side in FIG. 1A will be called the “front” of the waterproof connector, the rightward side in FIG. 1A will be called the “rear” of the waterproof connector, the upper side in FIG. 1A will be called the “top” of the waterproof connector and the lower side in FIG. 1A will be called the “bottom” of the waterproof connector. In FIGS. 3C and 5B, the leftward side will be called the “left” of the waterproof connector and the rightward side will be called the “right” of the waterproof connector.

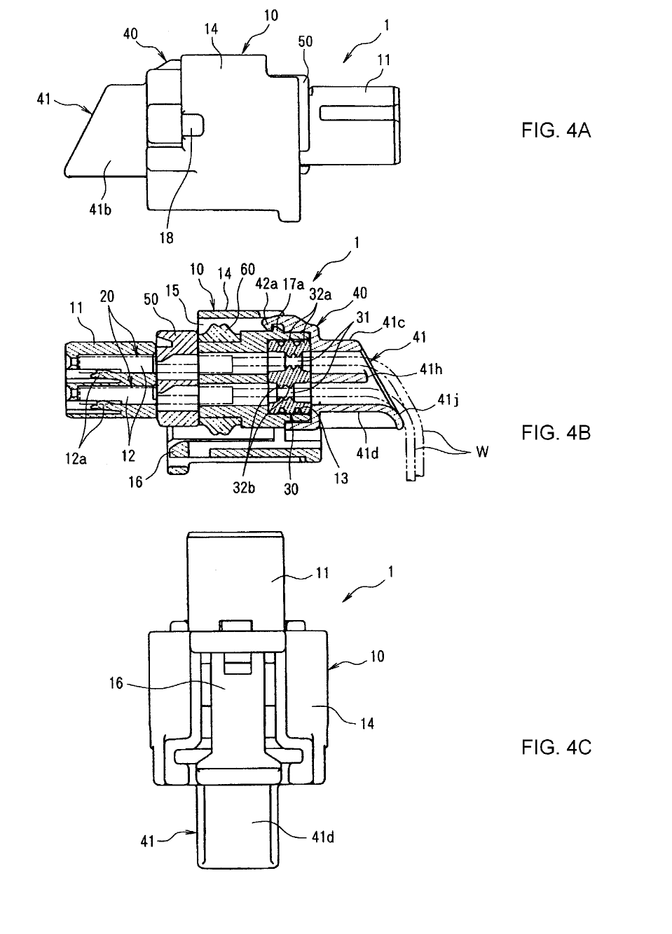

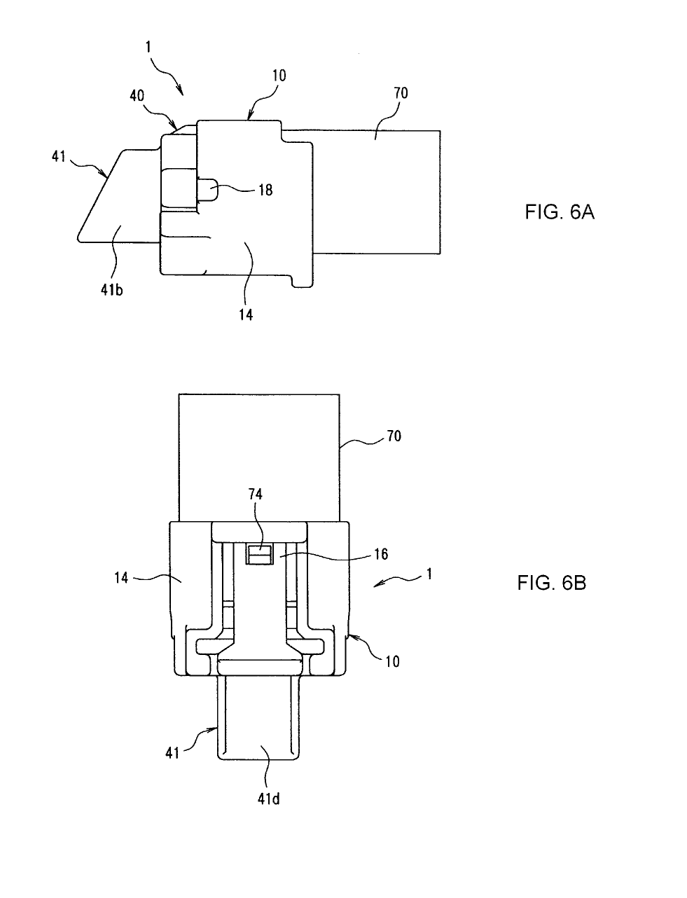

The housing 10 is formed by molding an insulative material and, as shown in FIGS. 1A-4C, is equipped with a contact holder 11 that has a substantially quadrangular cylindrical shape and has contact receiving openings 12 arranged in a plurality of rows. In this embodiment, the contact receiving openings 12 are provided in two rows, each consisting of three holes. As shown in FIG. 4B, housing lances 12a for the primary latching of the contacts 20 held in the contact receiving openings 12 are provided to the contact receiving openings 12. Also, as shown in FIG. 4B, a seal receiving area 13 for holding the family seal 30 is formed in the rear end (the right end in FIG. 1A) of the contact holder 11. A housing hood 14 extends forward from the rear end of the contact holder 11 so as to cover part of the periphery of the contact holder 11. As shown in FIG. 5C, a hood receiving section 15 that accepts a mating hood 71 of a mating connector 70 is formed between the contact holder 11 and the housing hood 14. As shown in FIGS. 4B and 6B, a mating latch 16 for latching and locking a latching protrusion 74 of the mating connector 70 is provided underneath the housing 1O. As shown in FIGS. 4B and 5C, protrusions 17a, 17b, and 17c for fixing the seal retention member 40 are formed on the rear end upper side, the rear end left side, and the rear end right side, respectively, of the contact holder 11 of the housing 10. Furthermore, as shown in FIG. 5C, a pair of drain holes 18 that communicate between the hood receiving section 15 and the outside are formed on the rear end left and right sides of the hood receiving section 15 of the housing 10. The drain hole 18 provided on the left side of the hood receiving section 15 passes through so as to communicate between the hood receiving section 15 and the outside at the rear end left side and rear end side of the housing hood 14, while the drain hole 18 provided on the right side of the hood receiving section 15 passes through so as to communicate between the hood receiving section 15 and the outside at the rear end right side and rear end side of the housing hood 14. Any water that has infiltrated the hood receiving section 15 can be drained to the outside from the drain holes 18.

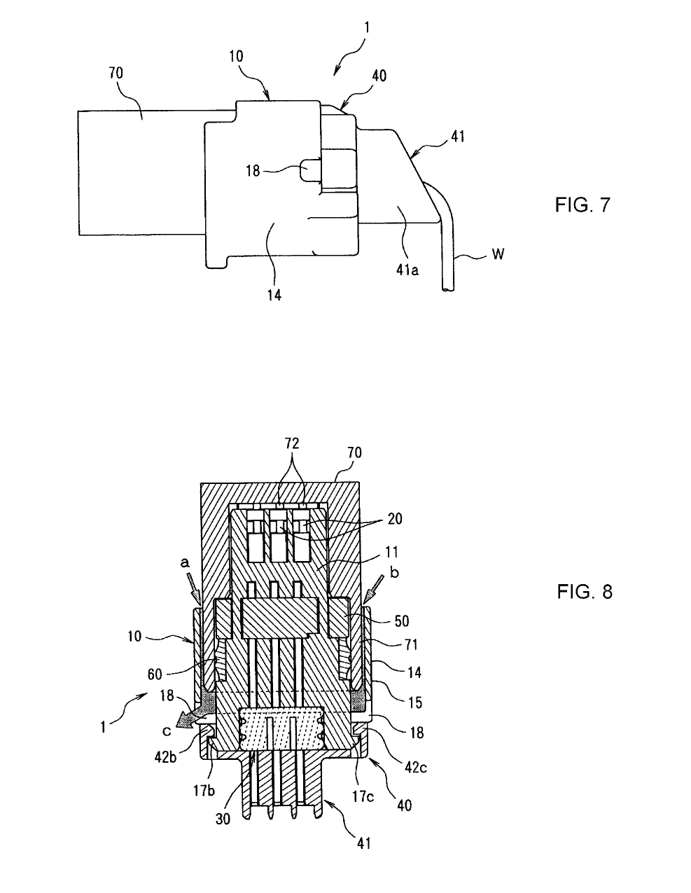

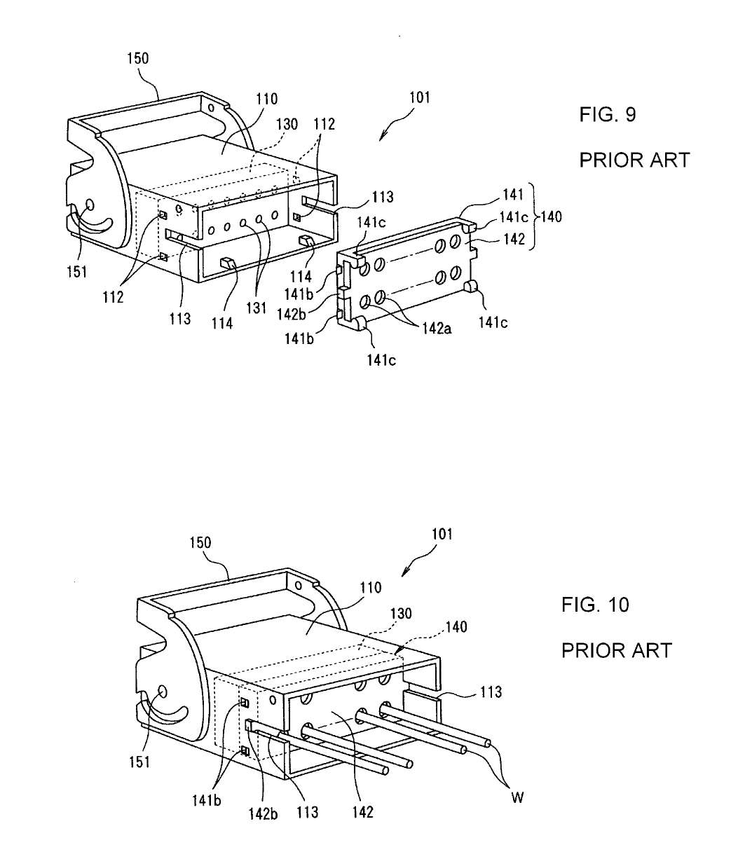

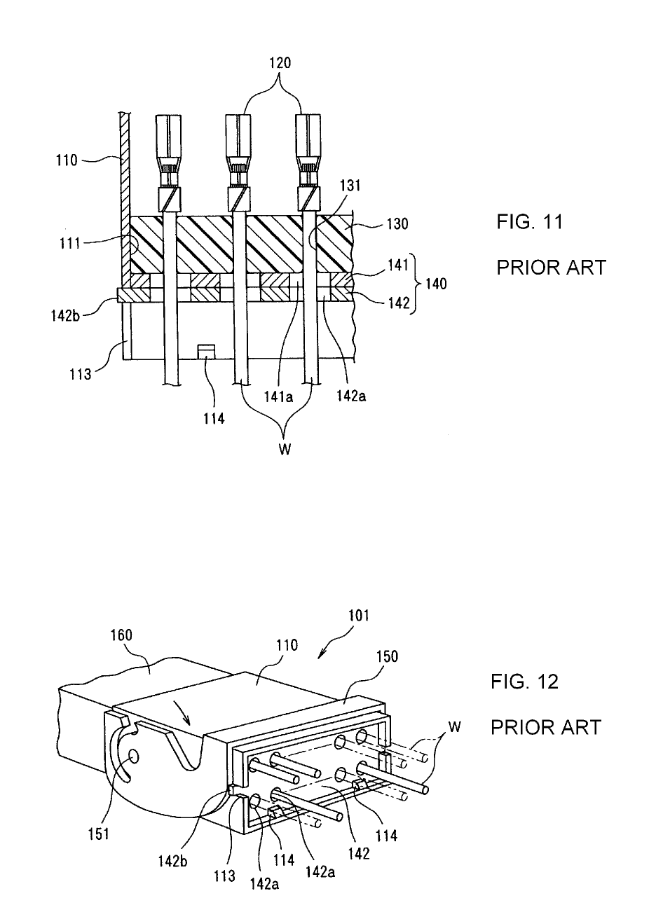

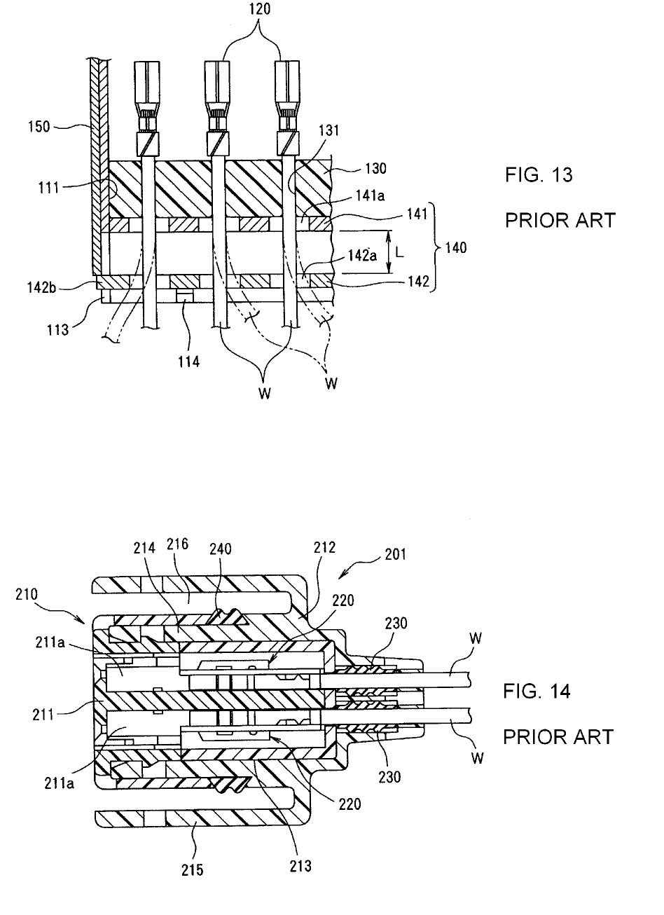

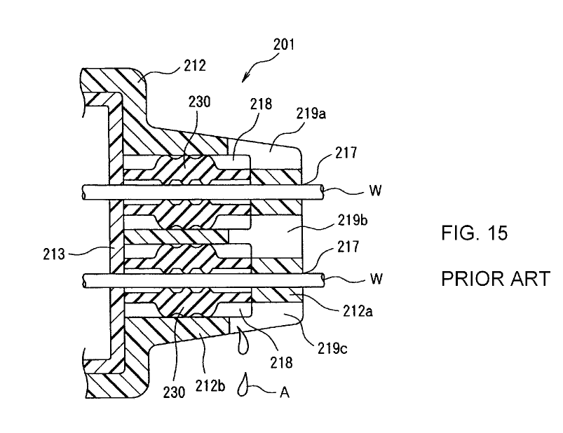

As shown in FIG. 4B, the contacts 20 are inserted from the rear end side of the housing 10 into the contact receiving openings 12 provided to the housing 10, and are primarily latched by the housing lances 12a. The contacts 20 are male contacts formed by stamping and/or bending sheet metal, and as shown in FIG. 8, they accept and come into contact with pin contacts 72 provided to the mating connector 70. Meanwhile, electrical wires W are connected to the contacts 20, and the electrical wires W are taken out from the rear of the housing 10.

As shown in FIGS. 4B and 5C, the family seal 30 is mounted in the seal receiving area 13 of the housing 10 from the rear side of the housing 10. This family seal 30 is a cluster-type waterproofing member made of rubber, and has a plurality of wire receiving passageways 31 that fit snugly around the periphery of the plurality of electrical wires W connected respectively to the plurality of contacts 20. The wire receiving passageways 31 are provided at locations corresponding to the contact receiving openings 12, and in this embodiment, they are provided in two rows, each consisting of three holes. As shown in FIG. 4B, a plurality of first seal protrusions 32a that fit snugly around the inner peripheral face of the seal receiving area 13 are provided to the outer peripheral face of the family seal 30, and a plurality of second seal protrusions 32b that fit snugly around the periphery of the electrical wires W are provided to the inner peripheral faces of the wire receiving passageways 31 of the family seal 30. Any water that makes its way in between the inner peripheral face of the seal receiving area 13 and the outer peripheral face of the family seal 30 from the rear of the housing 10 is prevented from infiltrating the interior of the housing 10 because the first seal protrusions 32a are snugly fitted around the inner peripheral face of the seal receiving area 13. Also, any water that makes its way in between the electrical wires W and the wire receiving passageways 31 of the family seal 30 from the rear of the housing 10 is prevented from infiltrating the interior of the housing 10 because the second seal protrusions 32b are snugly fitted around the outer peripheral face of the electrical wires W.

As shown in FIGS. 4B and 5C, the seal retention member 40 is attached to the housing 10 from the rear of the housing 10, and retains the family seal 30 held in the seal receiving area 13. As shown in FIG. 4B, a first retention latch 42a that is latched to the protrusion 17a provided to the rear end upper side of the contact holder 11 is provided to the upper part of the seal retention member 40; as shown in FIG. 5C, a second retention latch 42b that is latched to the protrusion 17b provided to the rear end left side of the contact holder 11 is provided to the left side of the seal retention member 40; and as shown in FIG. 5C, a third retention latch 42c that is latched to the protrusion 17c provided to the rear end right side of the contact holder 11 is provided to the right side of the seal retention member 40. When the first retention latch 42a, second retention latch 42b, and third retention latch 42c of the seal retention member 40 are latched to the protrusions 17a, 17b, and 17c, respectively, the seal retention member 40 is fixed to the rear end of the contact holder 11, and as a result retains the family seal 30 and prevents the family seal 30 from loosening.

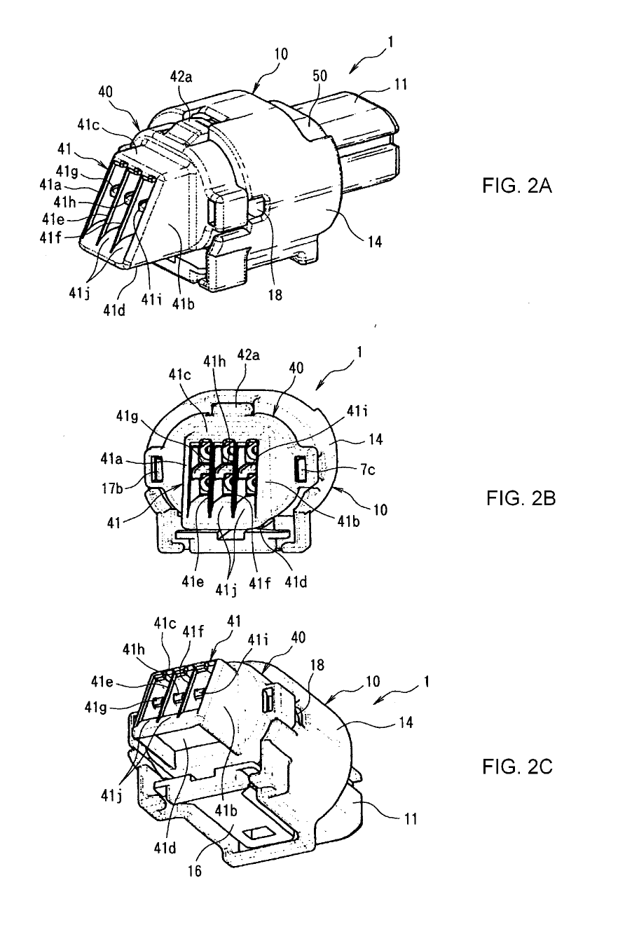

A wire guide 41 for linearly guiding the plurality of electrical wires W taken out from the plurality of wire receiving passageways 31 of the family seal 30 is integrally formed on the seal retention member 40. As shown in FIGS. 2-4, this wire guide 41 comprises a left side wall 41a that is located slightly to the left of the left-most wire receiving passageway 31 (the farthest left side in FIG. 3C) of the plurality of wire receiving passageways 31 provided in two rows, and extends linearly to the rear; a right side wall 41b that is located slightly to the right of the right-most wire receiving passageway 31 and extends linearly to the rear; an upper wall 41c that is located slightly above the wire receiving passageways 31 in the upper row and extends linearly to the rear; and a lower wall 41d that is located slightly below the wire receiving passageways 31 in the lower row and extends linearly to the rear. The wire guide 41 also comprises a first partition wall 41e that extends linearly to the rear from between the left-most wire receiving passageway 31 and the middle wire receiving passageway 31, and a second partition wall 41f that extends linearly to the rear from between the middle wire receiving passageway 31 and the right-most wire receiving passageway 31. The wire guide 41 further comprises a third partition wall 41g that extends linearly to the rear from in between the left-most wire receiving passageway 31 in the upper row and the left-most wire receiving passageway 31 in the lower row; a fourth partition wall 41 h that extends linearly to the rear from in between the middle wire receiving passageway 31 in the upper row and the middle wire receiving passageway 31 in the lower row; and a fifth partition wall 41i that extends linearly to the rear from in between the right-most wire receiving passageway 31 in the upper row and the right-most wire receiving passageway 31 in the lower row.

The electrical wire W is removed from the left-most wire receiving passageway 31 in the upper row of the family seal 30 by being guided linearly and rearwardly through the space bounded by the left side wall 41a, the upper wall 41c, the first partition wall 41e, and the third partition wall 41g. The electrical wire W is removed from the middle wire receiving passageway 31 in the upper row of the family seal 30 by being guided linearly and rearwardly through the space bounded by the first partition wall 41e, the upper wall 41c, the second partition wall 41f, and the fourth partition wall 41h. The electrical wire W is removed from the right-most wire receiving passageway 31 in the upper row of the family seal 30 by being guided linearly and rearwardly through the space bounded by the second partition wall 41f, the upper wall 41c, the right side wall 41b, and the fifth partition wall 41i. The electrical wire W is removed from the left-most wire receiving passageway 31 in the lower row of the family seal 30 by being guided linearly and rearwardly through the space bounded by the left side wall 41a, the third partition wall 41g, the first partition wall 41e, and the lower wall 41d. The electrical wire W is removed from the middle wire receiving passageway 31 in the lower row of the family seal 30 by being guided linearly and rearwardly through the space bounded by the first partition wall 41e, the fourth partition wall 41h, the second partition wall 41f, and the lower wall 41d. The electrical wire W is removed from the right-most wire receiving passageway 31 in the lower row of the family seal 30 by being guided linearly and rearwardly through the space bounded by the second partition wall 41f, the fifth partition wall 41i, the right side wall 41b, and the lower wall 41d.

As shown in FIG. 4B, a lead in surface 41j is provided to the rear end of the lower wall 41d of the wire guide 41. Lead in surface 41j guides the downward bending of the electrical wires W in the course of the electrical wires W being removed linearly from the wire receiving passageways 31 of the lower row.

Also, the secondary latching member 50 is attached so as to be capable of up and down movement with respect to the contact holder 11 of the housing 10, and after the contacts 20 held in the contact receiving openings 12 have been primarily latched by the housing lances 12a, the secondary latching member 50 moves downward and secondarily latches the contacts 20.

The annular sealing member 60 is attached on the outer periphery of the contact holder 11 and to the rear of the secondary latching member 50. The sealing member 60 is a rubber waterproofing member, and as shown in FIG. 5C, it fits snugly around the inner periphery of the mating hood 71 of the mating connector 70 accommodated in the hood receiving section 15 and around the inner periphery of the hood receiving section 15 (that is, the outer periphery of the contact holder 11), and prevents water that has infiltrated the hood receiving section 15 from getting into the contact holder 11.

In the assembly of the waterproof connector 1 shown in FIGS. 1A-4C, first, the family seal 30 is mounted inside the seal receiving area 13 of the housing 10, and then the seal retention member 40 is attached to the housing 10 from the rear of the housing 10, and retains the family seal 30 held in the seal receiving area 13. After this, the contacts 20 are passed through the wire guide 41 of the seal retention member 40 and then through the insertion holes 31 of the family seal 30, and thereby inserted into the contact receiving openings 12 provided to the housing 10. As a result, the contacts 20 are primarily latched by the housing lances 12a. The secondary latching member 50 is then moved downward so that the contacts 20 are secondarily latched by the secondary latching member 50 and prevented from coming loose from the contact receiving openings 12, completing the assembly of waterproof connector 1.

The completed waterproof connector 1 may be installed in any suitable location according to its intended use. More specifically, the waterproof connector 1 may be installed in a tight space, such as inside an automotive door, so that the plurality of electrical wires W end up being bent by about 90 degrees downward as shown in FIG. 4B. Even when this bending happens, the plurality of electrical wires W removed from the plurality of wire receiving passageways 31 of the family seal 30 will may be removed in a linear manner because they are guided linearly by the wire guide 41, and only then are they bent about 90 degrees downward. Accordingly, there is no risk that the bending of the electrical wires W will deform the family seal 30 and decrease the contact between the wire receiving passageways 31 (the second seal protrusions 32b) and the electrical wires W. This effectively prevents any water that gets in between the electrical wires W and the wire receiving passageways 31 (second seal protrusions 32b) of the family seal 30 from the rear of the housing 10 from infiltrating into the housing 10.

The waterproof connector 1 of this embodiment of the present invention differs from the waterproof connector 101 shown in Prior Art FIGS. 9-13 in the direction in which the plurality of electrical wires W are bent, and is applied when a predetermined direction (downward in this embodiment) is used, as shown in FIG. 4B. Therefore, the longitudinal length of the wire guide 41 can be shortened, and the longitudinal length of the waterproof connector 1 can be shortened.

As to the portion where the electrical wires W are linearly guided, with the waterproof connector 101 shown in Prior Art FIGS. 9-13, both the insertion holes 141a of the fixed plate 141 and the insertion holes 142a of the movable plate 142 are constituted by round holes that are slightly larger than the diameter of the electrical wires W, whereas with the waterproof connector 1 of this embodiment of the present invention, each space of the wire guide 41 is constituted in a quadrangular shape that is loose with respect to the diameter of the electrical wires W, so it is very easy to insert the electrical wires W into the wire guide 41.

Also, since the wire guide 41 is integrally molded into the seal retention member 40, there is no need to provide any special member for preventing a decrease in contact, so fewer parts are required and the total number of members is small, allowing for simple construction of the present invention. Furthermore, the operation of a rotary lever or other special member in taking out the electrical wires W is unnecessary, and the electrical wires W can be pulled out by pulling out them along the wire guide 41 of the seal retention member 40, allowing easier installation of the waterproof connector 1 of the present invention easier in a tight space.

The mating connector 70 is then mated as shown in FIGS. 5 to 8 to the waterproof connector 1, which has been installed in a suitable location as dictated by its intended application. When the mating connector 70 is mated to the waterproof connector 1, as shown in FIG. 8, the pin contacts 72 of the mating connector 70 come into contact with the contacts 20, thereby establishing an electrical connection.

Also, when the mating connector 70 is mated to the waterproof connector 1, as shown in FIG. 8, the mating hood 71 of the mating connector 70 is accommodated in the hood receiving section 15 of the waterproof connector 1, and the sealing member 60 fits snugly around the inner periphery of the mating hood 71. The sealing member 60 also fits snugly around the inner periphery of the hood receiving section 15 (that is, the outer periphery of the contact holder 11). Accordingly, as shown by the arrows a and b in FIG. 8, even if water should infiltrate the hood receiving section 15, it will be prevented by the sealing member 60 from infiltrating the contact holder 11.

Furthermore, since the pair of drain holes 18 for draining water that has infiltrated the hood receiving section 15 are provided to the hood receiving section 15 that accommodates the mating hood 71 of the mating connector 70, as shown by arrows a and b in FIG. 8, any water that has infiltrated into the hood receiving section 15 from the side where a mating connector 70 is mated up to just short of the sealing member 60 can be drained to the outside as indicated by arrow c from the drain holes 18. Therefore, no water will collect inside the hood receiving section 15, so even if the connector is exposed to temperatures below the freezing point, there is no risk that the portion of the housing 10 near the hood receiving section 15 will be damaged by freezing due to volumetric expansion when collected water turns into ice. In FIG. 8, water that has infiltrated into the hood receiving section 15 is drained from one of the drain holes 18 as indicated by arrow c, but depending on how the waterproof connector 1 is installed, the water may alternatively be drained from both of the drain holes 18, or may be drained only from the other drain hole 18.

To improve the performance of water drainage, it is preferable that the pair of drain holes 18 be aligned along a diagonal line with respect to the length of the housing 10. Also, depending on the size of the waterproof connector 1, the drain holes 18 are preferably provided at a location that will be facing down when installed or mounted.

The shape of the drain holes 18 may be quadrangular, round, or any other shape, but the holes must have a diameter large enough to let water run out naturally, or about 6 millimeters or larger.

An embodiment of the present invention was described above, but the present invention is not limited to this, and various modifications and improvements can be performed.

For instance, the wire guide 41 is not limited to the shape shown in FIGS. 2A-4C, as long as it will guide the plurality of electrical wires W linearly.

Also, the number and layout of the drain holes 18 are not limited to the example depicted in the drawings, as long as they allow water that has infiltrated into the hood receiving section 15 to be drained from the waterproof connector 1.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A waterproof connector, comprising:
an insulative housing having a rear end;
a contact attached to the housing;
a family seal mounted to the rear end, the family seal having a wire receiving passageway adapted to allow insertion of an electrical wire connected to the contact and to snugly fit around the electrical wire;
a seal retention member having a wire guide for linearly guiding the electrical wire, configured for connection to the insulative housing, and configured to retain the family seal.

2. The waterproof connector according to claim 1, further comprising:
a seal receiving area formed in the housing and configured to accept mounting of the family seal therein.

3. The waterproof connector according to claim 1, further comprising:
a protrusion on the insulative housing; and
a retention latch on the seal retention member configured for engagement with the protrusion.

4. The waterproof connector according to claim 1, further comprising:
a hood receiving section of the housing adapted to accept a mating hood of a mating connector.

5. The waterproof connector according to claim 1, further comprising:
a contact receiving opening formed in the housing accepting the contact therein.

6. The waterproof connector according to claim 5, further comprising:
a housing lance formed in the housing for latching the contact to the housing in the contact receiving opening.

7. The waterproof connector according to claim 6, further comprising:
a secondary latching member formed in the housing for latching the contact to the housing in the contact receiving opening after the housing lance has latched the contact to the housing in the contact receiving opening.

8. The waterproof connector according to claim 1, the family seal comprising:
a plurality of seal protrusions adapted to fit snugly around the electrical wire such that water is prevented from entering an interior of the housing.

9. The waterproof connector according to claim 1, wherein the wire guide is adapted to provide bending of the wire at about 90 degrees.

10. The waterproof connector according to claim 1, wherein the housing is adapted to mate with a mating connector thereby creating an electrical connection between the contact and a pin contact in the mating connector.

11. A waterproof connector, comprising:
an insulative housing having a hood receiving section adapted to mate with a mating hood of a mating connector;
a contact disposed in the housing;
a sealing member disposed between an inner periphery of the hood receiving section and an inner periphery of the mating hood of the mating connector; and
a drain hole formed in the hood receiving section for draining water that infiltrates the hood receiving section.

12. The waterproof connector according to claim 11, wherein the drain hole is aligned along a diagonal line with respect to the length of the housing.

13. The waterproof connector according to claim 11, wherein the contact is adapted to form an electrical connection with a pin contact of the mating connector when the mating connector is connected to the housing.

14. The waterproof connector according to claim 11, further comprising:
a family seal mounted to a rear end of the housing, the family seal having a wire receiving passageway adapted to allow insertion of an electrical wire connected to the contact and to snugly fit around the electrical wire.

15. The waterproof connector according to claim 14, further comprising:
a seal receiving area formed in the housing and configured to accept mounting of the family seal therein.

16. The waterproof connector according to claim 14, further comprising:
a plurality of seal protrusions adapted to fit snugly around the electrical wire such that water is prevented from entering an interior of the housing.

17. The waterproof connector according to claim 11, further comprising:
a seal retention member having a wire guide for linearly guiding the electrical wire, configured for connection to the insulative housing, and configured to retain the family seal.

18. The waterproof connector according to claim 17, wherein the wire guide is adapted to provide bending of the wire at about 90 degrees.

19. The waterproof connector according to claim 11, wherein a diameter of the drain hole is about 6 millimeters or larger.
